(19) United States
(12) Patent Application Publication
(10) Pub. No.: US 2005/0188840 A1
(43) Pub. Date: Sep. 1, 2005

(54) Internal combustion engine

(76) Inventor: Susumu Yasuyama, Iwata-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/051,556

(22) Filed: Feb. 4, 2005

(30) Foreign Application Priority Data
Feb. 6, 2004 (JP) 2004-031420
Jan. 19, 2005 (JP) 2005-011029

(51) Int. Cl. F16J 1/04

(52) U.S. Cl. 92/208

(57) ABSTRACT

A piston is constructed to have improved rigidity yet be relatively light weight. The piston includes a head section having a surface on one side thereof and a rear or bottom surface on the opposite side thereof. At lease one piston pin inserting section is provided on the rear side of the head section and is configured to receive at least a portion of a piston pin of the engine. At least one rib joins together the rear surface of the head section and the piston pin inserting section to increase the rigidity of the piston.

### RELATED CASES

The present application is based on and claims priority under 35 U.S.C. § 119(a-d) to Japanese Patent Application No. 2004-031420, filed on Feb. 6, 2004, and to Japanese Patent Applications No. 2005-011029, filed on Jan. 19, 2005, the entire contents of which are expressly incorporated by reference herein.

### BACKGROUND OF THE INVENTION

1. Field of the Invention

The present invention relates to an internal combustion engine and, in particular, to an internal combustion engine including a piston.

2. Description of Background Art

Piston rigidity have been improved using known techniques over the years, including the one disclosed, for example, in, for example, Japanese patent publication number JP-A-4-244673.

Japanese patent publication number JP-A-4-244673 discloses a technique for providing a reinforcing beam section in a piston, which also includes a skirt section and a piston pin insertion section (a pin boss section) on a rear surface side of a head section. The beam section connects the skirt section and the pin boss section to improve rigidity of the piston.

However, since the head section constituting the piston is not reinforced, when the piston is reduced in weight by, for example, reducing a thickness of the head section, design and performance complications typically arise as the rigidity of the head section decreases. If the head thickness were to be reduced on pistons used in a high power engine, the high loads produced by such an engine would tend to damage the head sections of the pistons. Consequently, the piston head design disclosed in Japanese Patent Publication No. JP-A-4-244673 can not be used in high power engines to obtain fuel economy through a reduction in weight of the pistons.

### SUMMARY OF THE INVENTION

A need therefore exists for a piston that is of relatively light weight yet posses the rigidity necessary for operation in high horsepower engine.

Accordingly, one aspect of the present invention involves a piston for an internal combustion engine that includes: a head section; at least one piston pin inserting section that is provided in an area of a rear surface of the head section and in which a piston pin is inserted; and at least one rib that is provided to connect the rear surface of the head section and the piston pin inserting section.

In the internal combustion engine according to the aspect, as described above, by providing at least one rib connecting the rear surface of the head section and the piston pin inserting section, the head section and the piston pin inserting section are reinforced by the rib. Thus, it is possible to improve rigidity of the piston. Consequently, even if a load applied to the piston increases because of high power of the internal combustion engine, it is possible to prevent the piston (the head section and the piston pin inserting section) from being damaged. In addition, for example, even when the piston is reduced in weigh by reducing a thickness of the head section, since the head section is reinforced by the rib, it is possible to prevent rigidity of the piston (the head section) from decreasing by a meaningful degree. As a result, it is possible to realize high power of the internal combustion engine while improving fuel efficiency through a reduction in weight of the piston. In addition, by improving rigidity of the piston with the at least one rib connecting the rear surface of the head section and the piston pin inserting section, compared with the case in which rigidity of the piston is improved by increasing the thickness of the head section and a thickness of the piston pin inserting section, it is possible to prevent a weight of the piston from increasing. Consequently, the rigidity of the piston head can be maintained (or increased) while reducing the weigh of the piston.

In a preferred mode, a pair of ribs are connected to the piston pin inserting section. It is further preferred that the pair of ribs are arranged such that the piston pin inserting section is disposed between the pair of ribs. With such a structure, it is possible to achieve reinforcement of the head section and the piston pin inserting section more surely.

In the structure in which the pair of ribs are connected to the piston pin inserting section, the piston preferably further includes a pair of skirt sections that extend from the vicinity of an outer periphery of the rear surface of the head section to an opposite side of the surface of the head section and are spaced apart so as to be opposed to each other. The pair of ribs are formed to extend from the piston pin inserting section to the vicinity of one and the other of the pair of skirt sections. With such a structure, it is possible to reinforce not only a portion of the head section located near the piston pin inserting section but also a portion of the head section located near the skirt sections.

In a further preferred mode, the piston includes a first piston pin inserting section and a second piston pin inserting section that are arranged to be opposed to each other and to be disposed apart from each other. The piston further includes (i) a first rib that is connected to a portion of the first piston pin inserting section opposed to the second piston pin inserting section and (ii) a second rib that is connected to a portion of the second piston pin inserting section opposed to the first piston pin inserting section. With such a structure, in which the piston includes the first piston pin inserting section and the second piston pin inserting section, it is possible to reinforce the head section, the first piston pin inserting section, and the second piston pin inserting section.

In a structure that includes the first rib and the second rib, the first rib and the second rib preferably are skewed (that is, as viewed in plan view, formed to extend in directions inclined at an angle) with respect to both a central axis of the piston pin inserting section and an orthogonal axis that is orthogonal to the central axis of the piston pin inserting section. With such a structure, it is possible to prevent the head section from bending along the central axis of the piston pin inserting section and to prevent the head section from bending along the orthogonal axis orthogonal to the central axis of the piston pin inserting section with the first rib and the second rib.

It is further preferred in such a piston construction for a distance, which is measured parallel to the central axis of the piston pin inserting section and between an end of the first rib on the opposite side of the first piston pin inserting section and an end of the second rib on the opposite side of the second piston pin inserting section, to be smaller than a second distance, which is measured parallel to the central axis and between an end of the first rib on the first piston pin inserting section side and an end of the second rib on the second piston pin inserting section side. With such a structure, it is possible to inhibit the head section from bending along the central axis of the piston pin inserting section and prevent the head section from bending along the orthogonal axis.

In a more preferred mode, the end of the first rib on the opposite side of the first piston pin inserting section is arranged to extend to the vicinity of the outer periphery of the rear surface of the head section and the end of the second rib on the opposite side of the second piston pin inserting section is arranged to extend to the vicinity of the outer periphery of the rear surface of the head section. With such a structure, it is possible to reinforce the entire head section with the first rib and the second rib.

The piston also can include at least one skirt section that extends from an area of the outer periphery of the rear surface of the head section in a direction on the opposite side of the surface of the head section and at least one wall that is provided to connect the rear surface of the head section, the piston pin inserting section, and the skirt section. With such a structure, since the head section, the piston pin inserting section, and the skirt section are reinforced by the wall, it is possible to further improve rigidity of the piston. Consequently, even if a load applied to the piston increases, it is possible for the piston to withstand such loads.

In the structure in which the at least one wall is connected to the skirt section, the piston preferably includes a first piston pin inserting section and a second piston pin inserting section that are arranged to oppose and be deposed apart from each other. The piston also preferably includes a first pair of first that are connected to the first piston pin inserting section and a second pair of walls that are connected to the second piston pin inserting section. With such a structure, it is possible to reinforce the head section, the first piston pin inserting section and the second piston pin inserting section, and the skirt section with the pair of first walls and the pair of second walls.

In the structure in which the wall includes the pair of first walls and the pair of second walls, the piston preferably also includes a first pair of ribs that are connected to a side surface side on an inner side of the first piston pin inserting section and a second pair of ribs that are connected to a side surface side on an inner side of the second piston pin inserting section. The first pair of walls are connected to a side surface side on an outer side of the first piston pin inserting section, and the second pair of walls are connected to a side surface side on an outer side of the second piston pin inserting section. With such a structure, since the inner side of the head section is reinforced by the first rib and the second rib and the outer side of the head section is reinforced by the first wall and the second wall, it is possible to reinforce the entire head section uniformly.

In the structure in which the piston includes first and second pairs of walls, the piston preferably also includes a first skirt section and a second skirt section that are arranged to be opposed to each other and be spaced apart from each other. One of the first pair of walls is provided to connect the first piston pin inserting section and one side end of the first skirt section and the other of the first pair of walls is provided to connect the first piston pin inserting section and one side end of the second skirt section. Additionally, one of the second pair of walls is provided to connect the second piston pin inserting section and the other side end of the first skirt section and the other of the second pair of walls is provided to connect the second piston pin inserting section and the other side end of the second skirt section. With such a structure, it is possible to reinforce the head section, the first piston inserting section and the second piston inserting section, and the first skirt section and the second skirt section with the first and second pairs of walls.

In the structure that includes first and second pairs of walls, the first pair of walls and the second pair of walls are skewed with respect to both a central axis of the piston pin inserting section and an orthogonal axis that is orthogonal to the central axis of the piston pin inserting section. With such a structure, it is possible to inhibit the head section from bending along the central axis of the piston pin inserting section and to inhibit the head section from bending along the orthogonal axis orthogonal to the central axis of the piston pin inserting section with the first walls and the second walls. In addition, in a plan view, since the first walls and the second walls are formed to extend in the directions inclined at an angle with respect to both the central axis of the piston pin inserting section and the orthogonal axis, when an external force is applied to the first skirt section and the second skirt section in a central direction of the piston, the first walls and the second walls tend to bend. Thus, it is possible to withstand the external force applied to the first skirt section and the second skirt section with the first walls and the second walls.

In the structure in which the first walls and the second walls are skewed with respect to both the central axis of the piston pin inserting section and the orthogonal axis, preferably a distance, which is measured parallel to the central axis of the piston pin inserting section and between ends of the first walls on the opposite side of the first piston pin inserting section and ends of the second walls on the opposite side of the second piston pin inserting section, is larger than a second distance that is measured parallel to the central axis of the piston pin inserting section and between ends of the first walls on the first piston pin inserting section side and ends of the second walls on the second piston pin inserting section side. With such a structure, it is possible to inhibit the head section from bending along the central axis of the piston pin inserting section and to inhibit the head section from bending along the orthogonal axis orthogonal to the central axis of the piston pin inserting section with the first walls and the second walls.

### BRIEF DESCRIPTION OF THE DRAWINGS

These and other features, aspects and advantages of the present invention are now described with reference to the drawings of a preferred embodiment, which is intended to illustrate and not to limit the present invention, and in which:

FIG. 1 is a sectional view along a pin boss central axis around a piston of an internal combustion engine according to a preferred embodiment of the invention;

FIG. 2 is a sectional view along an axis orthogonal to the pin boss central axis around the piston of FIG. 1;

FIG. 3 is a perspective view of the piston of FIG. 1 taken from an upper side view thereof;

FIGS. 4 is a perspective view of the piston of FIG. 3 taken from an lower side view thereof;

FIG. 5 is a bottom perspective view of the piston of FIG. 4;

FIG. 6 is a side view of the piston of FIG. 3 as viewed from a skirt section side thereof;

FIG. 7 is a side view of the piston of FIG. 3 as viewed from a pin boss section side thereof;

FIG. 8 is a top plan view of the piston of FIG. 3 showing a surface side thereof; and

FIG. 9 is a bottom plan view of the piston of FIG. 3.

### DETAILED DESCRIPTION OF THE PREFERRED EMBODIMENT

An embodiment of the invention will be hereinafter explained on the basis of the drawings.

First, a structure of a four-cycle internal combustion engine 1 in which a piston 3 in the form of a preferred embodiment can be used. All or some of the aspects and features of the present piston design, however, can be used with other types of internal combustion engines; for example, some or all of the aspects and features of the present piston design can be used with engines that have different numbers of cylinders, have different cylinder arrangements, use different ignition schemes, employ different fuel charging devices (e.g., direct fuel injection) and different valve arrangements and operation (e.g., VVT and VVL), and/or operate on different combustion principles (e.g., a two-stroke internal combustion engine).

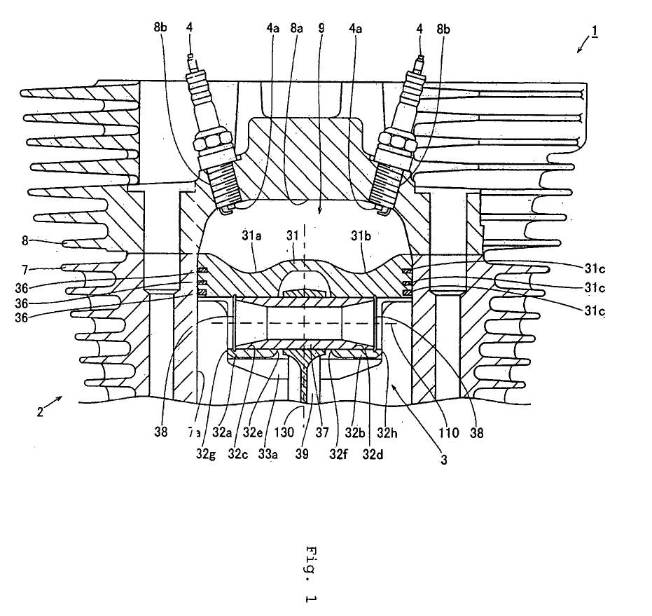

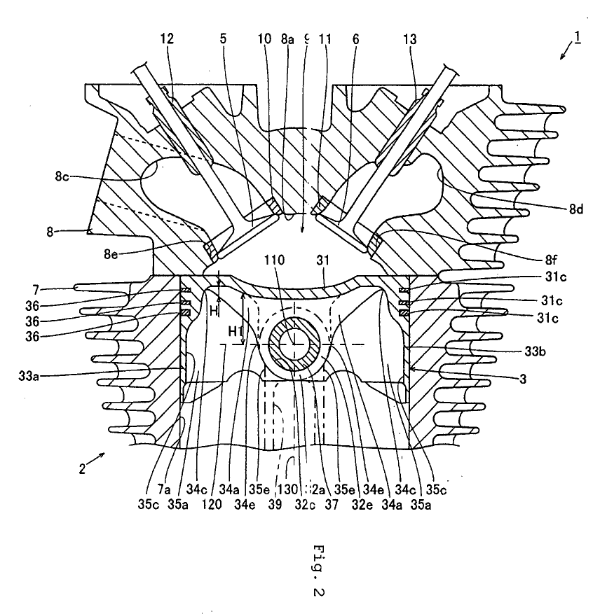

As shown in FIGS. 1 and 2, the four-cycle internal combustion engine 1 according to this embodiment includes a cylinder 2, a piston 3 preferably of aluminum cast, two spark plugs 4, an intake valve 5, and an exhaust valve 6 (see FIG. 2). The cylinder 2 includes a cylinder body 7 set on a crank case (not shown) side and a cylinder head 8 attached to the cylinder body 7. A cylinder bore 7a is formed in the cylinder body 7, and a recess 8a constituting a combustion chamber 9 is formed in the cylinder head 8. The recess 8a of the cylinder head 8 is arranged to correspond to a position of the cylinder bore 7a. In other words, an opening on the cylinder head 8 side of the cylinder bore 7a is closed by the recess 8a of the cylinder head 8. In addition, as shown in FIG. 1, two ignition element attaching sections 8b preferably are formed in the cylinder head 8b. Ignition elements (e.g., spark plugs 4) are attached to the attaching sections 8b. Electric discharge sections 4a (i.e., the spark gap) of the spark plugs 4 project into the recess 8a of the cylinder head 8.

As shown in FIG. 2, the cylinder head 8 includes at least one intake passage 8c for supplying a mixture of gasoline and air to the combustion chamber 9 and at least one exhaust passage 8d for discharging a burnt charge (i.e., the exhaust gas) from the combustion chamber 9. Although one intake passage 8c and one exhaust passage 8d are shown in FIG. 2, respectively, actually, a pair of intake passages 8c and a pair of exhaust passages 8d are preferably formed in the cylinder head 8. The pair of intake passages 8c and the pair of exhaust passages 8d are combined to be one intake passage 8c and one exhaust passage 8d, respectively, in the cylinder head 8. A valve seat 10 is defined to an opening (an intake port) 8e on the combustion chamber 9 (the recess 8a) of the intake passage 8c and a valve seat 11 is defined to an opening (an exhaust port) 8f on the combustion chamber 9 side of the exhaust passage 8d. The valve seats 10, 11 preferably consist of a material having satisfactory abrasion resistance, heat resistance, and heat conductivity. The valve seats 10, 11 are provided to control abrasion of the intake port 8e and the exhaust port 8f and to dissipate heat from the intake valve 5 and the exhaust valve 6. In addition, guide members 12, 13 are attached to the intake passage 8c side and the exhaust passage 8d side of the cylinder head 8, respectively. The intake valve 5 is arranged in a portion corresponding to the intake port 8e and the exhaust valve 6 is arranged in a portion corresponding to the exhaust port 8f. The intake valve 5 and the exhaust valve 6 have functions of opening and closing the intake port 8e and the exhaust port 8f, respectively. In addition, the intake valve 5 and the exhaust valve 6 are guided by the guide members 12, 13, respectively. The description of the engine thus far is believed to be conventional and further description thereof is not necessary for an understand of the present piston construction.

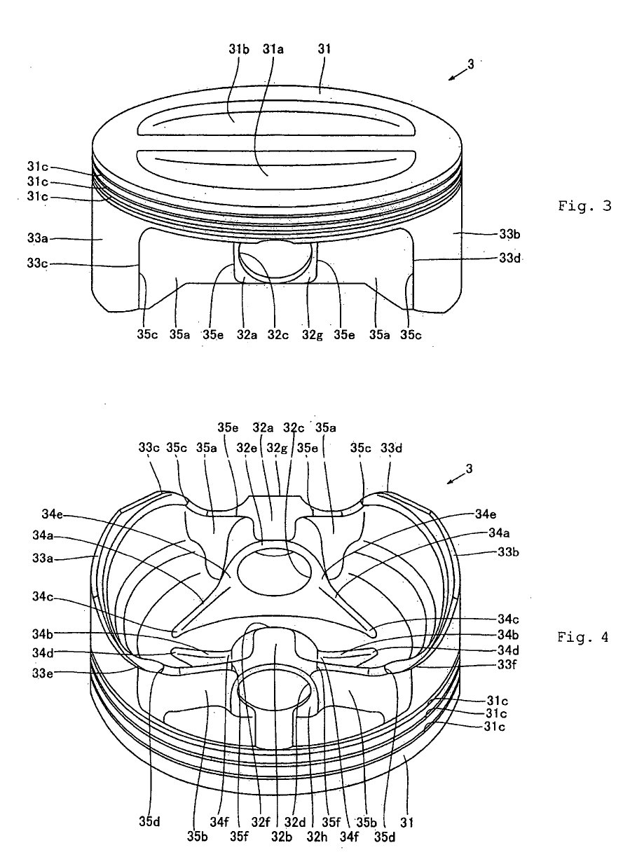

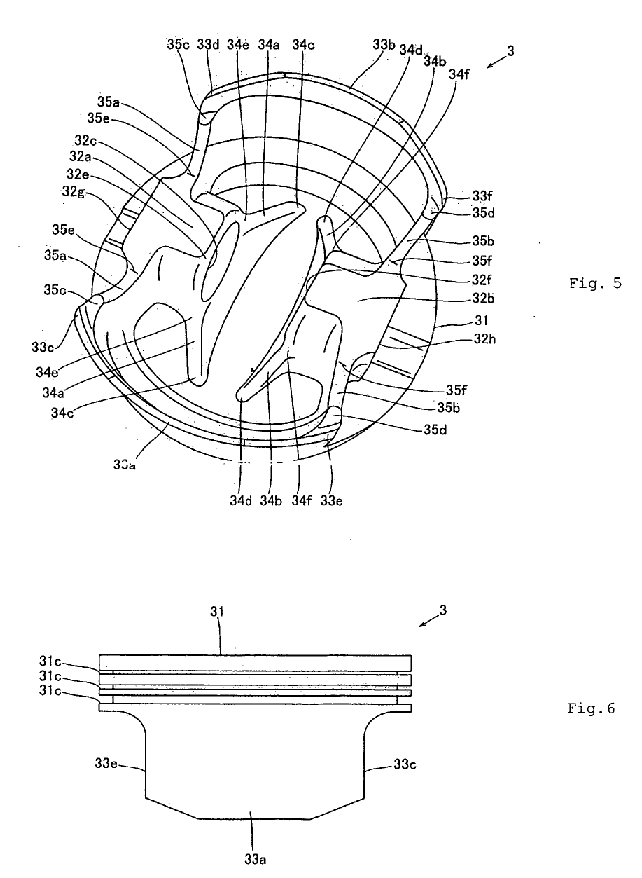

As shown in FIGS. 3 to 5, the piston 3 has a structure including a head section 31, a pair of pin boss sections 32a, 32b, and a pair of skirt sections 33a, 33b. The pin boss section 32a is an example of the “piston pin inserting section” and the “first piston pin inserting section” of a piston and the pin boss section 32b is an example of the “piston pin inserting section” and the “second piston pin inserting section” of a piston. The skirt sections 33a, 33b are examples of the “first skirt section” and the “second skirt section” of a piston, respectively.

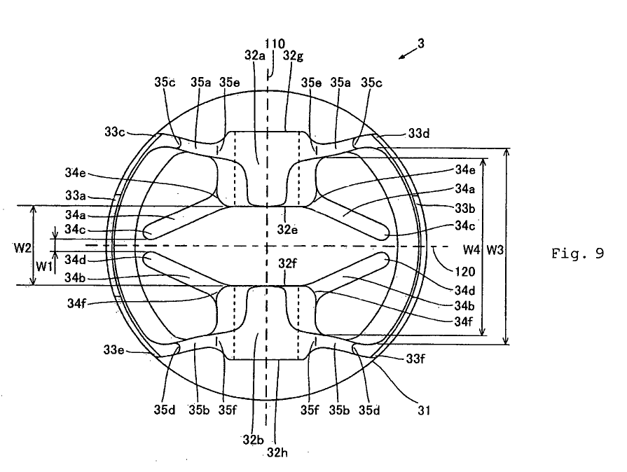

The piston 3 preferably includes at least one recess on an upper surface thereof (i.e., the surface that faces into the combustion chamber 9). In the illustrated embodiment, as shown in FIGS. 3 and 8, two recesses 31a, 31b having a designed depth are formed in the surface of the head section 31. As shown in FIG. 8, in a plan view, the recesses 31a, 31b preferably have substantially a semicircular shape. In addition, the recesses 31a and 31b are arranged such that linear portions thereof (that is, the straight edges thereof) are opposed to each other. The piston, however, need not include one or more recesses, nor do the recesses need to be of the same shape, be of the same size, or be symmetrically positioned relative to a central plane of the piston.

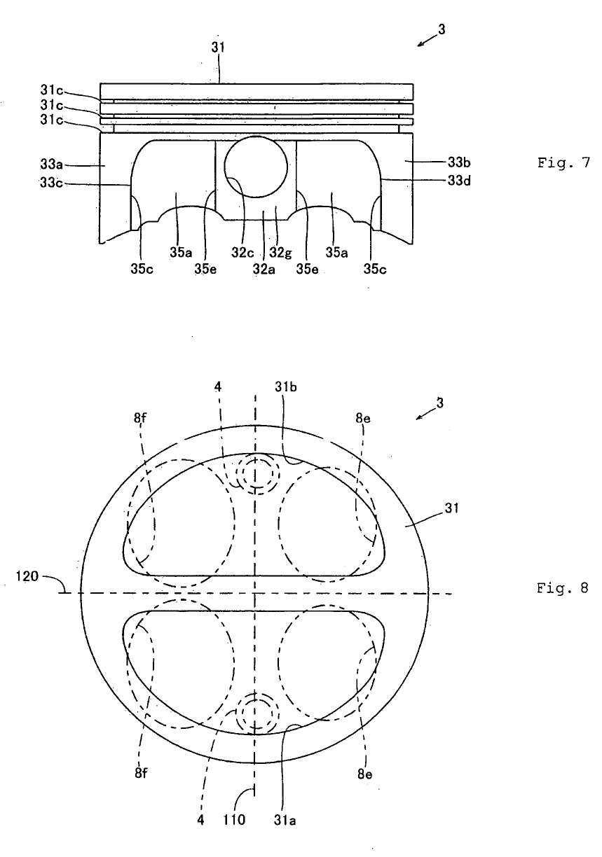

The piston preferably carries at least one sealing element to inhibit gases within the chamber from blowing by the piston into the crankcase. As shown in FIGS. 1 to 4, 6, and 7, three ring grooves 31c having a designed depth are preferably formed in an outer peripheral surface (a side) of the head section 31. The three ring grooves 31c are provided in order to fix three piston rings 36 to be described later to the head section 31. Fewer or greater rings, however, can be used.

As shown in FIGS. 1 to 5 and 9, the pair of pin boss sections 32a, 32b are provided integrally on the rear surface of the head section 31. The pin boss sections 32a, 32b are spaced apart from the outer periphery of the head section 31 by equal distances. The pin boss sections 32a, 32b are arranged to oppose each other at a generally precise distance. In addition, holes 32c, 32d, in which a piston pin 37 is inserted, are formed in the pin boss sections 32a, 32b, respectively.

In the illustrated embodiment, as shown in FIGS. 4, 5, and 9, the piston includes on a rear or lower surface of the head section 31, a pair of ribs 34a. The ribs 34a are connected to and integrated with the rear surface of the head section 31 and the pin boss section 32a. The piston 3 similarly includes a pair of ribs 34b that are connected to and integrated with the rear surface of the head section 31 and the pin boss section 32b. The ribs 34a, 34b are examples of the “first rib” and the “second rib” of a piston, respectively. The present embodiment illustrates a further preferred arrangement of the ribs 324, 34b. As shown, the pair of ribs 34a preferably are connected to a side surface 32e side on an inner side of the pin boss section 32a so as to dispose the pin boss section 32a between the pair of ribs 34a, and the pair of ribs 34b are preferably connected to a side surface 32f side on an inner side of the pin boss section 32b so as to dispose the pin boss section 32b between the pair of ribs 34b.

With reference to FIG. 9, the ribs 34a, 34b are arranged to extend in directions skewed at an angle with respect to both a central axis 110 of the pin boss sections 32a, 32b (hereinafter referred to as pin boss central axis 110) and an orthogonal axis 120 that lies normal to the pin boss central axis 110. More specifically, a distance W1, which is measured parallel to the pin boss central axis 110 and between ends 34c of the ribs 34a on the opposite side of the pin boss section 32a and ends 34d of the ribs 34b on the opposite side of the pin boss section 32b, is smaller than a second distance W2, which is measured in a direction parallel to the pin boss central axis 110 and between ends 34e on the pin boss section 32a side of the ribs 34a and ends 34f on the pin boss section 32b side of the ribs 34b.

The ends 34c of the ribs 34a and the ends 34d of the ribs 34b are arranged near an outer periphery (the skirt sections 33a and 33b) on the rear surface of the head section 31. As shown in FIGS. 2, 4, and 5, the ribs 34a preferably are formed such that a height H from the rear surface of the head section 31 gradually increases from the ends 34c on the opposite side of the pin boss section 32a towards the ends 34e on the pin boss section 32a side. The ribs 34b are formed such that a height from the rear surface of the head section 31 gradually increases from the ends 34d on the opposite side of the pin boss section 32b toward the ends 34f on the pin boss section 32b side. A height H1 of the ends 34e of the ribs 34a and the ends 34f of the ribs 34b from the rear surface of the head section 31 preferably is made to substantially the same as a height H1 of the pin boss central axis 110 from the rear surface of the head section 31 (see FIG. 2).

As shown in FIGS. 1 to 7 and 9, the pair of skirt sections 33a, 33b are formed to extend in the same direction on the opposite side of the surface of the head section 31 from the outer periphery of the rear surface of the head section 31. In addition, the skirt sections 33a, 33b are arranged to oppose each other at a designed spacing (i.e., a predetermined interval) in a direction parallel to the orthogonal axis 120.

In the illustrated embodiment, as shown in FIGS. 4, 5, and 9, on the rear surface of the head section 31, a pair of walls 35a are integrally provided with the juxtaposed elements of the piston. The walls 35a connect together the rear surface of the head section 31, the pin boss section 32a, and the skirt sections 33a, 33b. Similarly, a second pair of walls 35b are integrally provided with the juxtaposed elements of the piston. The second pair of walls 35b connect together the rear surface of the head section 31, the pin boss section 32b, and the skirt sections 33a and 33b. The walls 35a, 35b in the illustrated embodiment are examples of the “first walls” and the “second walls” of a piston, respectively. In a preferred form, one of the pair of walls 35a is provided to connect the pin boss section 32a and one side end 33c of the skirt section 33a and the other of the pair of walls 35a is provided to connect the pin boss section 32a and one side end 33d of the skirt section 33b. One of the pair of walls 35b is provided to connect the pin boss section 32b and the other side end 33e of the skirt section 33a and the other of the pair of walls 35b is provided to connect the pin boss section 32b and the other side end 33f of the skirt section 33b. The pair of walls 35a are connected to a side of a side surface 32g on an outer side of the pin boss section 32a and the pair of walls 35b are connected to a side of a side surface 32h on an outer side of the pin boss section 32b.

As best seen in FIG. 9, the walls 35a, 35b are arranged to extend in directions skewed at an angle with respect to both the pin boss central axis 110 and the orthogonal axis 120. More specifically, a distance W3, which is measured in a direction parallel to the pin boss central axis 110 and between ends 35c of the walls 35a on the opposite side of the pin boss section 32a and ends 35d of the walls 35b on the opposite side of the pin boss section 32b, is larger than a distance W4, which is measured in a direction parallel to the pin boss central axis 110 and between ends 35e on the pin boss section 32a side of the walls 35a and ends 35f on the pin boss section 32b side of the walls 35b.

As shown in FIGS. 1 and 2, piston rings 36 are attached to the respective three ring grooves 31c of the head section 31 of the piston 3. In a state in which the piston rings 36 are attached to the ring grooves 31c of the head section 31, the piston 3 is fitted into the cylinder bore 7a of the cylinder body 7. Therefore, general air tightness of the combustion chamber 9, which is formed in part by the surface of the head section 31 of the piston 3, is achieved by the piston rings 36. In addition, as shown in FIG. 8, the spark plugs 4, the intake ports 8e, and the exhaust ports 8f preferably are arranged in areas corresponding to the recesses 31a, 31b of the head section 31 of the piston 3, respectively.

As shown in FIG. 1, the piston pin 37 is inserted in the pin boss sections 32a, 32b (through the holes 32c, 32d) of the piston 3. This piston pin 37 is preferably fixed within the holes 32c, 32d by a C ring 38. The piston pin 37 pivotally attaches a connecting rod 39 to the piston 3. This connecting rod 39 is movable in a direction in which the cylinder axis 130 extends in synchronization with a rotational movement of a crankshaft (not shown). Consequently, the piston 3 coupled via the piston pin 37 to the connecting rod 39 reciprocates in the direction in which the cylinder axis 130 extends in synchronization with the rotational movement of the crankshaft.

In the illustrated embodiment, as described above, the ribs 34a, 34b reinforce the head section 31 and the pin boss sections 32a, 32b on the rear surface of the head section 31. This construction increases the rigidity of the piston 3. Consequently, even if a high load is applied to the piston 3 (for example, if the piston is used in a high powered engine) the piston 3 can withstand such load and not be damaged. In addition, by improving rigidity of the piston 3 with the ribs 34a, 34b, it is possible to reduce the weight of the piston 3 without significantly sacrificing the rigidity of the piston 3 by increasing an overall thickness of the head section 31 and a thickness of the pin boss sections 32a, 32b.

Consequently, it is possible to increase the rigidity of the piston 3 without significantly increasing the weight of the piston 3 so as not to sacrifice fuel efficiency to any meaningful degree.

In the illustrated embodiment, the pair of ribs 34a are arranged so as to dispose the pin boss section 32a between the pair of ribs 34a and the pair of ribs 34b are arranged so as to dispose the pin boss section 32b between the pair of ribs 34b. This arrangement reinforces the head section 31 as well as the pin boss sections 32a, 32b.

The piston preferably is constructed such that the distance W1 is smaller than the distance W2 (as seen FIG. 9). Consequently, it is possible to inhibit the head section 31 from bending along the pin boss central axis 110 and to inhibit the head section 31 from bending along the orthogonal axis 120.

Additionally, the ends 34c of the ribs 34a, which are on the opposite side of the pin boss section 32a, and the ends 34d of the ribs 34b, which are on the opposite side of the pin boss section 32b, are preferably arranged near the outer periphery (the skirt sections 33a, 33b) on the rear surface of the head section 31. This arrangement reinforces not only portions of the head section 31 located near the pin boss sections 32a, 32b but also portions located near the skirt sections 33a, 33b. The ribs 34a, 34b also reinforce the entire head section 31 when so arranged.

The height H of the ribs 34a, as measured from the rear surface of the head section 31, preferably increases gradually from the ends 34c on the opposite side of the pin boss section 32a toward the ends 34e on the pin boss section 32a side. Similarly, the height of the ribs 34b from the rear surface of the head section 31 preferably increases gradually from the ends 34d on the opposite side of the pin boss section 32b toward the ends 34f on the pin boss section 32b side. Consequently, it is possible to substantially reinforce of the pin boss sections 32a, 32b, to which a large external force is applied when the four-cycle internal combustion engine 1 is operated. In this case, the piston can be formed such that (1) the height H1 of the ends 34e on the pin boss section 32a side of the ribs 34a is substantially the same as the height H1 of the pin boss central axis 110 from the rear surface of the head section 31, and (2) the height of the ends 34f on the pin boss section 32b side of the rib 34b is substantially the same as the height of the pin boss central axis 110 from the rear surface of the head section 31. Consequently, it is possible to prevent the reinforcement for the pin boss sections 32a, 32b by the ribs 34a, 34b from becoming excessive. Thus, it is possible to prevent the weight of the piston 3 from significantly increases as a result of the reinforcement of the pin boss sections 32a, 32b by the ribs 34a, 34b becoming excessive.

In the illustrated embodiment, on the rear surface of the head section 31, the pair of walls 35a, which connect the rear surface of the head section 31, the pin boss section 32a, and the skirt sections 33a and 33b, are provided and the pair of walls 35b, which connect the rear surface of the head section 31, the pin boss section 32b, and the skirt sections 33a and 33b, are provided. Consequently, the head section 31, the pin boss section 32a, and the skirt sections 33a and 33b are reinforced by the pair of walls 35a and the head section 31, the pin boss section 32b, and the skirt sections 33a and 33b are reinforced by the pair of walls 35b. This construction further improves the rigidity of the piston 3.

In this embodiment, the piston 3 is constituted such that the distance W3 is larger than the distance W4 (as seen in FIG. 9). This arrangement of the ribs 34a, 34b inhibits the head section 31 from bending along the pin boss central axis 110 and inhibits the head section 31 from bending along the orthogonal axis 120. In addition, the walls 35a, 35b are formed to extend in the direction skewed with respect to both the pin boss central axis 110 and the orthogonal axis 120. When an external force is applied to the skirt sections 33a, 33b generally along the cylinder axis 130, the walls 35a, 35b tend to bend. Thus, the walls 35a, 35b absorb the external force applied to the skirt sections 33a and 33b. Consequently, it is possible to inhibit damage to the piston 3 in cases where a large external force is applied to the skirt sections 33a, 33b.

In this embodiment, the ribs 34a, 34b are connected to the side of the side surface 32e on the inner side of the pin boss section 32a and the side of the side surface 32f on the inner side of the pin boss section 32b. The walls 35a, 35b are connected to the side of the side surface 32g on the outer side of the pin boss section 32a and the side of the side surface 32h on the outer side of the pin boss section 32b. In an embodiment so constructed, the inner side of the head section 31 is reinforced by the ribs 34a, 34b and the outer side of the head section 31 is reinforced by the walls 35a, 35b. Thus, it is possible to reinforce the entire head section 31 substantially uniformly.

In this embodiment, the two recesses 31a and 31b having the predetermined depth are formed on the surface of the head section 31. Consequently, it is possible to easily obtain a reduction in weigh of the piston 3 while keeping rigidity of the piston 3 with the ribs 34a and 34b.

Although this invention has been disclosed in the context of certain preferred embodiments, it will be understood by those skilled in the art that the present invention extends beyond the specifically disclosed embodiments to other alternative embodiments and/or uses of the invention and obvious modifications and equivalents thereof. For example, in the illustrated embodiment, the ribs are arranged to extend in the directions skewed with respect to both the pin boss central axis and the orthogonal axis. However, the ribs can be arranged to extend in a direction parallel to the orthogonal axis or in a direction parallel to the pin boss central axis. It is further understood that, while the walls are arranged in the illustrated embodiment to extend in the directions skewed with respect to both the pin boss axis and the orthogonal axis, the walls can be arranged to extend in a direction parallel to the orthogonal axis. Such variations are merely examples of the various embodiments of which the invention can take.

It is also contemplated that various combinations or sub-combinations of the specific features and aspects of the embodiment may be made and still fall within the scope of the invention. For example, in the illustrated embodiment, the ribs connecting the rear surface of the head section and the pin boss section and the walls connecting the rear surface of the head section, the pin boss section, and the skirt sections are provided. However, in some applications only the ribs may be provided without providing the walls. It should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above, but should be determined only by a fair reading of the claims that follow.

1. An internal combustion engine comprising a piston that include:
a head section;
at least one piston pin inserting section that is provided on a rear surface of the head section, the piston pin inserting section being configured to receive at least a portion of a piston pin of the engine; and
at least one rib joining together the rear surface of the head section and the piston pin inserting section.

2. An internal combustion engine according to claim 1, wherein a pair of ribs are connected to the piston pin inserting section.

3. An internal combustion engine according to claim 2, wherein the pair of ribs are arranged such that the piston pin inserting section is disposed between the pair of ribs.

4. An internal combustion engine according to claim 2 additionally comprising a pair of skirt sections that extend from a vicinity of an outer periphery of the rear surface of the head section to an opposite side of a surface of the head section, the skirt sections being spaced part and opposing each other, each one of the pair of ribs extending from the piston pin inserting section to a vicinity of one of the pair of skirt sections.

5. An internal combustion engine according to claim 1 additionally comprising:
a second piston pin inserting section that opposes and is spaced apart from the first piston pin inserting section; and
a second rib connected to a portion of the second piston pin inserting section.

6. An internal combustion engine according to claim 5, wherein each rib extends in a direction that skewed relative to both a central axis of the piston pin inserting section and an orthogonal axis, which is orthogonal to the central axis of the piston pin inserting section.

7. An internal combustion engine according to claim 6, wherein distance measured in a direction parallel to the central axis of the piston pin inserting section and between an end of the first rib on the opposite side of the first piston pin inserting section and an end of the second rib on the opposite side of the second piston pin inserting section is smaller than a distance measured in a direction parallel to the central axis of the piston pin inserting section and between an end of the first rib on the first piston pin inserting section side and an end of the second rib on the second piston pin inserting section side.

8. An internal combustion engine according to claim 5, wherein
the end of the first rib on the opposite side of the first piston pin inserting section extends to the vicinity of the outer periphery of the rear surface of the head section and the end of the second rib on the opposite side of the second piston pin inserting section extends to the vicinity of the outer periphery of the rear surface of the head section.

9. An internal combustion engine according to claim 1, additionally comprising:
at least one skirt section extending from an area of the outer periphery of the rear surface of the head section in a direction on the opposite side of the surface of the head section, and
at least one wall connecting the rear surface of the head section, the piston pin inserting section, and the skirt section.

10. An internal combustion engine according to claim 9, additionally comprising:
a second piston pin inserting section that opposes and is spaced apart from the first piston pin inserting, and
a plurality of walls, including said wall, in which at least a first pair of walls of said plurality are connect to the first piston pin inserting section and at least a second pair of walls are connected to the second piston pin inserting section.

11. An internal combustion engine according to claim 10, additionally comprising:
a plurality of ribs of which said rib is a part, at least a first pair of ribs of said plurality being connected to a side surface side on an inner side of the first piston pin inserting section and at least a second pair of ribs of said plurality being connected to a side surface side on an inner side of the second piston pin inserting section,
the first pair of walls being connected to a side surface side on an outer side of the first piston pin inserting section, and
the second pair of walls being connected to a side surface side on an outer side of the second piston pin inserting section.

12. An internal combustion engine according to claim 10, additionally comprising a second skirt section that opposes and is disposed apart from the first skirt section, and wherein one of the first pair of walls connects to the first piston pin inserting section and one side end of the first skirt section and the other of the first pair of walls is provided connects to the first piston pin inserting section and one side end of the second skirt section, and one of the second pair of walls connects to the second piston pin inserting section and the other side end of the first skirt section and the other of the second pair of second walls connects to the second piston pin inserting section and the other side end of the second skirt section.

13. An internal combustion engine according to claim 12, wherein the first pair of walls and the second pair of walls are skewed with respect to both a central axis or the piston pin inserting section and an orthogonal axis that is orthogonal to the central axis of the piston pin inserting section.

14. An internal combustion engine according to claim 13, wherein a distance, which is measured in a direction parallel to the central axis of the piston pin inserting section and between ends of the first walls on the opposite side of the first piston pin inserting section and ends of the second walls on the opposite side of the second piston pin inserting section, is larger than a distance, which is measured in a direction parallel to the central axis of the piston pin inserting section and between ends of the first walls on the first piston pin inserting section side and ends of the second walls on the second piston pin inserting section side.

15. An internal combustion engine according to claim 14, additionally comprising a second rib, the first and second ribs connecting to the first piston pin inserting section and the second piston pin inserting section, respectively, and wherein a distance, as measured in a direction parallel to the central axis of the piston pin inserting section and between ends of the first ribs on the opposite side of the first piston pin inserting section and ends of the second ribs on the opposite side of the second piton pin inserting section, is smaller than a distance that is measured parallel to the central axis of the piston pin inserting section and between ends of the first ribs on the first piston pin inserting section side and ends of the second ribs on the second piston pin inserting section.

16. An internal combustion engine according to claim 1, wherein the rib is formed such that a height thereof from the rear surface of the head section gradually increases from the opposite side of the piston pin inserting section toward the piston pin inserting section side.

17. An internal combustion engine according to claim 16, wherein the height of the end on the piston pin inserting section side of the rib from the rear surface of the head section is substantially the same as a height of the central axis of the piston pin inserting section from the rear surface of the head section.

18. An internal combustion engine according to claim 1, wherein the head section includes a surface with at least one recess.

19. An internal combustion engine according to claim 18, wherein two recesses are formed in the surface of the head section, and the two recesses are symmetrically position on the surface of the head section.
